(19) United States
(12) Patent Application Publication
(10) Pub. No.: US 2009/0026730 A1
(43) Pub. Date: Jan. 29, 2009

(54) BALL MOUNT AND HITCH BALL ASSEMBLY

(76) Inventor: Donald R. Frantz, New Berlin, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 11/782,873

(22) Filed: Jul. 25, 2007

(51) Int. Cl. B60D 1/06

(52) U.S. Cl. 280/511

(57) ABSTRACT

An assembly provides for a ball mount, a hitch ball and means for securing the hitch ball to the ball mount. It also provides means for preventing rotation of the hitch ball during attachment of the hitch ball to the ball mount. This rotation-preventing means comprises a geometrically-profiled aspect of both the ball mount and the hitch ball such that the relative position of the two elements is maintained during attachment of the hitch ball to the ball mount as well as when the hitch ball is removed from the ball mount.

### FIELD OF THE INVENTION

The present invention relates generally to hitch assemblies that are used for connecting a towed vehicle, such as a trailer, to a towing vehicle. More specifically, it relates to a ball mount and hitch ball assembly that is attachable to the hitch receiver of the towing vehicle, the ball mount and hitch ball assembly being configured to prevent rotation of the hitch ball when the hitch ball is being attached to, or removed from, the ball mount.

### BACKGROUND OF THE INVENTION

Hitch assemblies are well known in the art. Such assemblies are used with towing vehicles, such as cars and trucks, to allow them to pull towed vehicles, such as boat trailers, pop-up campers and the like, behind them. In one very common assembly, the towing vehicle is fitted with a hitch assembly having a tow hitch, which is a square-shaped hollow receiver tube mounted to the chassis of a towing vehicle at the rear of the vehicle. A portion of a ball mount is then inserted into the hollow of the receiver tube with the remaining portion of the ball mount extending rearwardly of the towing vehicle. That is, the ball mount includes a bar that fits into the receiver that is attached to the vehicle and is secured to the receiver by pinning it. The ball mount includes a hitch ball that is attached to it and the bar of the ball mount my drop down to get the ball closer to the ground so that the towed vehicle, or trailer, will ride level.

The towed vehicle, or trailer, is then fitted with a device that is used to secure the trailer to the towing vehicle. This is known as the trailer “tongue” or trailer “coupler” which captures the hitch ball and secures the towed vehicle to the towing vehicle. This forms an effective “ball and socket” connection to allow for relative movement between the towing vehicle and the towed vehicle, or trailer, while towing over a road surface.

In the hitch assembly described above, the hitch ball is typically removably attached to the ball mount. In this type of assembly, the hitch ball includes an integrally-formed ball that extends above the ball mount, a flange of some sort disposed immediately below the ball, a shank that extends through an aperture defined within the ball mount, and a threaded shank portion that extends below the ball mount. The threaded shank portion is used to secure the hitch ball to the ball mount by means of a like-threaded fastener, such as a hex nut.

The hitch ball of this type of assembly is usually attached to the ball mount by using a wrench or other tool to rotate the fastener about the threaded shank portion of the hitch ball. This can and does result in the hitch ball being rotated as well with the net effect that the combined fastener and hitch ball are simply rotated together within the aperture of the ball mount and the fastener is not advanced along the threaded shank. To properly secure the fastener and hitch ball to the ball mount, the hitch ball must be prevented from rotating within the ball mount aperture. This can be accomplished by using two wrenches or tools, whereby one is used to hold the hitch ball in position and the other is used to rotate the fastener and advance it along the threaded shank. This is awkward and potentially unsafe.

Certain “anti-rotation” configurations have been devised and are also known in the prior art. For example, U.S. Pat. No. 6,908,098 to Milazzo discloses and claims a non-rotating hitch ball wherein a plate and stud attachment is used in conjunction with a bore that lies adjacent the drawbar passageway. In U.S. Pat. Pub. No. 2005/0040623 by Krespach et al., a shaped recess is defined about the hitch ball mounting aperture and a like-shaped shank is configured as part of the hitch ball. In the experience of this inventor, such designs require additional parts, additional machining and, in the case of the recessed-aperture configuration, do not work quite as well as intended. That is, once the fastener is sufficiently rotated downwardly along the threaded hitch ball shank, the hitch ball flange may be easily displaced from the recess that it is intended to be seating within. Once displaced, the flange and recess combination will continue to be ineffective in preventing rotation of the hitch ball whenever any slight upward force is exerted on the hitch ball, which will cause the flange to “unseat” from the recess.

### SUMMARY OF THE INVENTION

In the view of this inventor, what is needed is a ball mount and hitch ball assembly that can be used whereby rotation of the hitch ball within the aperture of the ball mount is prevented during attachment of the hitch ball to the ball mount and during the full rotational movement of the fastener along the threaded hitch ball shank. What is also needed is such a ball mount and hitch ball assembly that can also allow for use of hitch balls having round, threaded shanks of current manufacture.

The present invention provides such an assembly that, when used properly, prevents rotation of the hitch ball during assembly. The assembly of the present invention provides for a ball mount, a hitch ball and means for removably attaching the hitch ball to the ball mount. It also provides means for preventing rotation of the hitch ball during attachment of the hitch ball to the ball mount. This rotation-preventing means comprises a geometrically-profiled aspect of both the ball mount and the hitch ball such that the relative position of the two elements is maintained during attachment of the hitch ball to the ball mount as well as when the hitch ball is removed from the ball mount.

The foregoing and other features of the assembly of the present invention will be apparent from the detailed description that follows.

### BRIEF DESCRIPTION OF THE DRAWINGS

FIG. 1 is a right side elevational view of a preferred embodiment of the ball mount and hitch ball assembly that is constructed in accordance with the present invention.

FIG. 2 is an expanded bottom, left side and front perspective view of the assembly shown in FIG. 1.

FIG. 3 is an enlarged and partially sectioned top plan view of the assembly shown in FIG. 1 and taken along line 3-3 of FIG. 1.

FIG. 4 is a further enlarged and partially sectioned right side elevational view of the assembly shown in FIG. 1 and taken along line 4-4 of FIG. 3.

### DETAILED DESCRIPTION OF THE INVENTION

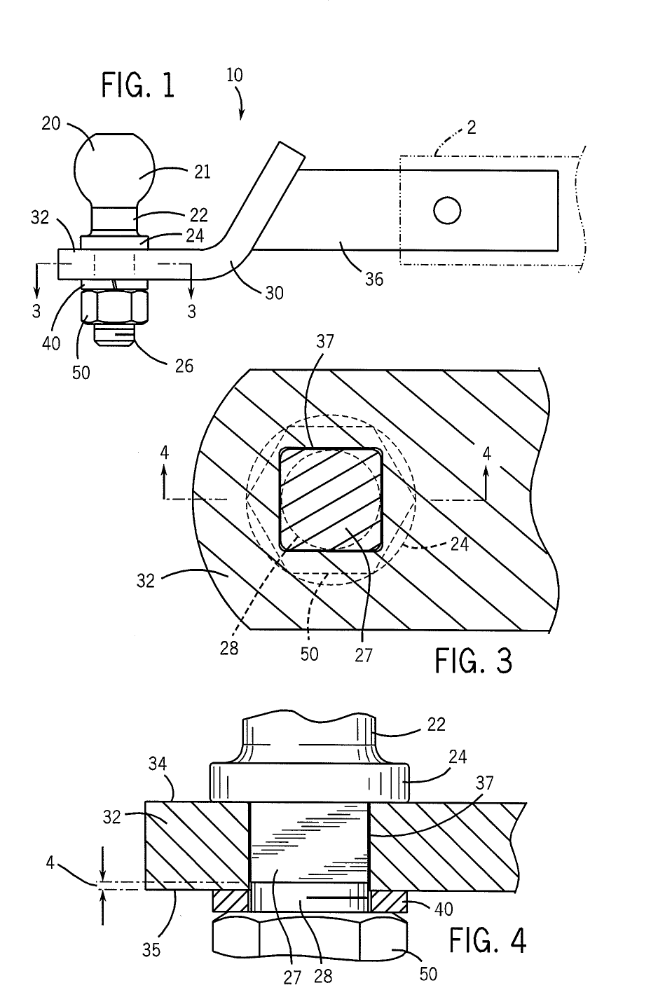

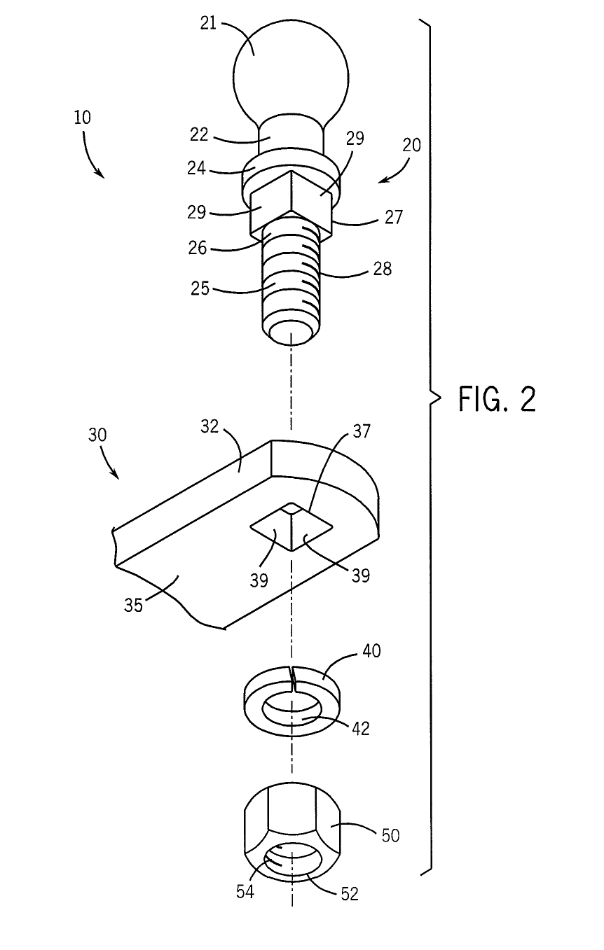

Referring now to the drawings in detail, wherein like numbered elements correspond to like elements throughout, FIG. 1 is a side elevational view showing the ball mount and hitch ball assembly, generally identified 10, constructed in accordance with the present invention. As shown in FIG. 2, it will be seen that the assembly 10 comprises several component parts. The primary parts are the hitch ball 20 and the hitch ball mount 30. The assembly 10 also comprises means for removably attaching the hitch ball 20 to the ball mount 30.

Referring back to FIG. 1, it will be seen that the hitch ball 20 is attachable to the ball mount 30 when it is necessary to use the hitch ball 20 to attach a suitable trailer hitch (not shown) to it. The ball mount 30 includes a rearwardly-extending (that is, extending “rearward” relative to the towing vehicle) flat portion 32 and a forwardly-extending, square-profiled portion 36, the forwardly-extending portion 36 being adapted to be received within a hollow hitch receiver 2 (shown in phantom view in FIG. 1) of the conventional two inch (2″) square type that is mounted to many towing vehicles of current construction. It is to be understood, however, that the assembly 10 of the present invention is not limited to that specific type of towing arrangement and that the assembly 10 could, with modification from that illustrated in FIG. 1, be utilized with other towing arrangements of current manufacture. In particular, the assembly 10 could be configured to comply with the common SAE classes I, II, III and IV for various loads, as well as for metric dimensioning and ISO compliance in countries of operation other than the United States.

Referring again to FIG. 2, it will be seen that the hitch ball 20 is comprised of the upper ball portion 21, an upper shank portion 22, a circumferential flange 24 and a lower shank portion 26. The upper ball portion 21, the shank portions 24, 26 and the flange 24 are preferably integrally-formed as a single unit. The lower shank portion 26 is further comprised of a geometrically-profiled portion 27 and a round-profiled threaded portion 28. The geometrically-profiled portion 27 of the lower shank portion 26 is of a length that corresponds substantially to, but slightly shy of, the thickness of the flat portion 32 of the ball mount 30. The reason for this will be apparent later in this detailed description. In the assembly 10 of the present invention, the geometrically-profiled portion 27 is square-shaped. As such, the square-profiled portion 27 is defined by four side walls 29 in the preferred embodiment of the present invention.

The ball mount 30 in the assembly 10 of the present invention further includes the rearwardly-extending flat portion 32 having a thickness that is defined by an upper surface 34 and a bottom surface 35. The flat portion also has a geometrically-profiled aperture 37 that extends from the upper surface 34 of the flat portion 32 and all of the way through to the bottom surface 35 of the flat portion 32. In the assembly 10 of the present invention, the geometrically-profiled aperture 37 is square-shaped and is defined by four side walls 39.

The assembly 10 of the present invention further includes a ring-shaped split washer 40, also commonly known as a “lock washer.” This split washer 40 further defines a centrally-disposed aperture 42.

Finally, the assembly 10 further includes a fastener 50 which, in the preferred embodiment, is a hexagonally-shaped nut 50 having a threaded aperture 52 centrally-disposed within it. The threads 54 of the aperture 52 of the nut 50 are functionally adapted to match the threads 25 of the threaded portion 28 of the lower shank 26 of the hitch ball 20 such that the nut 50 may be threadably mounted onto, and rotatably advanced along, the lower shank 26 of the hitch ball 20.

In application, the user would first position the hitch ball 20 above the rearwardly-extending portion 32 of the ball mount 30 such that the lower shank 26 is aligned with the aperture 37 of the ball mount 30. The hitch ball 20 would then be lowered to the point that the threaded portion 28 of the lower shank 26 extends through the ball mount aperture 37. The user would then continue to lower the hitch ball 20 to the point that sidewalls 29 of the square-profiled portion 27 of the lower shank 26 would be aligned generally with the side walls 39 of the ball mount aperture 37. Like the adage that “you can't put a square peg in a round hole,” the adjacent alignment of the respective side walls 29, 39 must be accomplished in order to further insert the lower shank 26 of the hitch ball 20 fully into the ball mount aperture 37. See FIG. 3 in this regard.

Once the lower shank 26 of the hitch ball 20 is properly aligned and fully inserted, the hitch ball 20 and the ball mount 30 will be in a relative position as is shown in FIGS. 1 and 4. In this position, it is to be noted that the flange 24 of the hitch ball 20 will rest upon the top surface 34 of the ball mount 30 to prevent the hitch ball 20 from being further lowered through the ball mount 30. This ensures that the ball portion 21 of the hitch ball 20 will extend substantially upwardly from the ball mount 30. In this position, it will also be seen that the bottom-most portion of the square-profiled portion 27 is just shy of the bottom surface 35 of the ball mount 30 by a dimension 4. See FIG. 4 in particular. This small dimension 4 is, in the preferred embodiment, necessary to make sure that the square-profiled portion 27 does not interfere with the proper seating of the washer 40 and otherwise prevent the washer 40 from being positioned immediately adjacent the bottom surface 35 of the ball mount 30. At this point, the washer 40 and the threaded hex nut 50 may be inserted over the threaded portion 28 of the lower shank 26 of the hitch ball 20. The nut 50 is then tightened as the washer 40 engages the bottom surface 35 of the ball mount 30 and is captured between that surface 35 and the nut 50. Of significant note is the fact that this tightening can be accomplished with the use of a single fastening device, such as a wrench (not shown), as rotation of the hitch ball 20 within the ball mount aperture 37 is completely prevented in the assembly 10 of the present invention.

In the assembly 10 of the present invention, it should also be noted that a hitch ball of other manufacture (not shown) having a conventional one inch (1″) round shank could also be utilized with the ball mount 30 of the present invention. Thus, in the assembly 10 of the present invention, one can “put a round peg in a square hole.” That is, while the hitch ball 20 of the present invention includes the square-profiled lower shank portion 27, it is to be noted that the square faces 29 of this portion 27 are approximately one inch (1″) to a side and closely approximate the one inch (1″) threaded portion 28 of the lower shank 26 of the hitch ball 20. This feature makes the assembly 10 of the present invention uniquely versatile in the art as well as easy to use.

Additional advantages and modifications will readily occur to those skilled in the art. Therefore, the invention in its broader aspects is not limited to the specific details disclosed and described herein. Most notably would be the concept that the through-aperture 37 of the ball mount 30 be configured in a different geometrical shape and that the otherwise square-profiled portion 27 of the lower shank 26 of the hitch ball 20 be like configured in that different geometrical shape. Accordingly, various modifications may be made without departing from the spirit or scope of the general inventive concept, although this inventor believes that the square-profiled aperture 37 and the square-profiled shank portion 27 is easiest to manufacture and most compatible with other hitch balls of current manufacture.

What is claimed is:

1. A ball mount and hitch ball assembly comprising:
a ball mount having a geometrically-shaped hitch ball receiving aperture, said aperture extending fully through the ball mount in that geometric shape; and
a hitch ball having a lower shank, the lower shank comprising a like geometrically-profiled portion and a threaded portion;
wherein rotation of the hitch ball relative to the ball mount is prevented when the geometrically-profiled portion of the hitch ball lower shank is received by the geometrically-profiled receiving aperture of the ball mount.

2. The assembly of claim 1 further comprising means for removably attaching the hitch ball to the ball mount.

3. The assembly of claim 2 wherein the hitch ball attachment means comprises a like-threaded fastener having an aperture, the aperture being configured to threadably receive the threaded portion of the hitch ball shank.

4. The assembly of claim 3 wherein the geometrically-profiled ball mount aperture and the geometrically-profiled lower hitch ball portion are each square-shaped.

5. The assembly of claim 1 wherein the ball mount has a thickness and the geometrically-profiled portion of the hitch ball lower shank is of a length that substantially matches the thickness of the ball mount.

6. The assembly of claim 5 wherein the geometrically-profiled ball mount aperture and the geometrically-profiled lower hitch ball portion are each square-shaped.

7. The assembly of claim 1 wherein the ball mount has a thickness and the geometrically-profiled portion of the hitch ball lower shank is of a length that is slightly less than the thickness of the ball mount.

8. The assembly of claim 7 wherein the geometrically-profiled ball mount aperture and the geometrically-profiled lower hitch ball portion are each square-shaped.

9. The assembly of claim 1 wherein the ball mount further comprises a bottom surface and wherein the geometrically-shaped portion does not extend below the bottom surface of the ball mount.

10. The assembly of claim 9 wherein the geometrically-profiled ball mount aperture and the geometrically-profiled lower hitch ball portion are each square-shaped.

11. A ball mount and hitch ball assembly comprising:
a ball mount having a square-shaped hitch ball receiving aperture, said aperture extending fully through the ball mount; and
a hitch ball having lower shank, the lower shank comprising a like square-shaped portion and a threaded portion, the square-shaped portion of the lower shank and the square-shaped receiving aperture of the ball mount being like dimensioned such that the square-shaped portion of the lower shank is receivable within the square-shaped receiving aperture of the ball mount and rotation of the hitch ball relative to the ball mount is prevented thereby.

12. The assembly of claim 11 further comprising means for removably attaching the hitch ball to the ball mount.

13. The assembly of claim 12 wherein the hitch ball attachment means comprises a like-threaded fastener having an aperture, the aperture being configured to threadably receive the threaded portion of the hitch ball shank.

14. The assembly of claim 13 wherein the ball mount has a thickness and the square-shaped portion of the hitch ball lower shank is of a length that substantially matches the thickness of the ball mount.

15. The assembly of claim 13 wherein the ball mount has a thickness and the geometrically-profiled portion of the hitch ball lower shank is of a length that is slightly less than the thickness of the ball mount.

16. The assembly of claim 13 wherein the geometrically-profiled ball mount aperture and the geometrically-profiled lower hitch ball portion are each square-shaped.

17. The assembly of claim 13 wherein the ball mount further comprises a bottom surface and wherein the geometrically-shaped portion does not extend below the bottom surface of the ball mount.
